(19) United States
(12) Patent Application Publication
(10) Pub. No.: US 2026/0318693 A1
(43) Pub. Date: Oct. 15, 2026

(54) ACCURATE DENSE RANGE ESTIMATION FROM IMAGES THROUGH AUXILIARY THREE-DIMENSIONAL SENSOR GUIDED REFINEMENT

(71) Applicant: GM Global Technology Operations LLC, Detroit, MI (US)

(72) Inventors: Roy Uziel, Bat Yam (IL); Oded Bialer, Petach Tikva (IL)

(21) Appl. No.: 19/174,491

(22) Filed: Apr. 9, 2025

(51) Int. Cl. G01C 21/34; G01S 17/86; G01S 17/89; G06V 10/75; G06V 10/82; G06V 20/56

(52) U.S. Cl. CPC G01C 21/34; G01S 17/86; G01S 17/89; G06V 10/751; G06V 10/82; G06V 20/56

(57) ABSTRACT

A method for navigating an autonomous vehicle. A camera image is obtained of a viewing area. A first range field is determined for the camera image, the first range field including first range pixels, each first range pixel storing a first range for a respective image pixel of the camera image. A reference field of the viewing area includes reference points corresponding to a subset of the first range pixels. Each reference point indicates a reference range of a corresponding first range pixel. A correction function provides a difference between the reference points and the subset of first range pixels. The correction function is applied to the first range pixels to obtain second range pixels of a second range field, each second range pixel storing a corrected range for the respective image pixel. The autonomous vehicle is navigated with respect to the object based on the second range field.

### INTRODUCTION

The subject disclosure relates to autonomous vehicles and, in particular, to a system and method of determining ranges to objects imaged by a camera of the vehicle and navigating a vehicle autonomously based on the ranges.

An autonomous vehicle includes various sensors that can detect objects in a field of view of the vehicle. For example, a camera on the vehicle can be used to obtain an image of the objects. Ranges to the objects can be determined from the image and the vehicle can be navigated with respect to the objects based on the ranges. Standard methods of range determination can give a good relative range between objects in an image but are not able to provide an accurate range with respect to the camera/vehicle. Accordingly, it is desirable to provide a method for determining an accurate range to an object in an image obtained at the autonomous vehicle.

### SUMMARY

In one exemplary embodiment, a method of navigating an autonomous vehicle is disclosed. A camera image is obtained of a viewing area, wherein an image pixel of the camera image is associated with an object in the viewing area. A first range field is determined for the camera image, the first range field including a plurality of first range pixels, each first range pixel corresponding to a respective image pixel and storing a first range for the respective image pixel. A reference field is obtained for the viewing area from an auxiliary range sensor, the reference field including a plurality of reference points corresponding to a subset of the plurality of first range pixels, wherein each reference point indicates a reference range of a corresponding first range pixel of the subset of first range pixels. A correction function is determined from a difference between the plurality of reference points and the subset of the plurality of first range pixels. The correction function is applied to the plurality of first range pixels to obtain a plurality of second range pixels of a second range field, each second range pixel corresponding to the respective image pixel and storing a corrected range for the respective image pixel. The autonomous vehicle is navigated with respect to the object based on the second range field.

In addition to one or more of the features described herein, the first range field includes a non-subset range pixel that is not a member of the subset of the plurality of first range pixels, wherein obtaining the second range field further comprises obtaining the corrected range for the non-subset range pixel.

In addition to one or more of the features described herein, the method further includes determining the correction function further comprising determining a loss function based on the difference between the plurality of reference points and the subset of the plurality of first range pixels and reducing the loss function to obtain the second range field from the first range field.

In addition to one or more of the features described herein, the method further includes training a convolutional neural network by reducing the loss function and using the trained convolutional neural network to determine the second range field.

In addition to one or more of the features described herein, the method further includes determining a polynomial parameter of a linear equation between the first range and the reference range and using the polynomial parameter to determine the corrected range.

In addition to one or more of the features described herein, the method further includes applying the polynomial parameter to all of the plurality of first range pixels of the first range field.

In addition to one or more of the features described herein, the auxiliary range sensor is at least one of Lidar and radar.

In another exemplary embodiment, a system for navigating an autonomous vehicle is disclosed. The system includes a camera configured to obtain a camera image of a viewing area, wherein an image pixel of the camera image is associated with an object in the viewing area, an auxiliary range sensor for obtaining a reference field for the viewing area, and a processor. The processor is configured to determine a first range field for the camera image, the first range field including a first range pixel having a first range for the object, determine a reference range for a reference point of the reference field, wherein the reference range corresponds to the first range pixel and indicates a reference range for the object, obtain a second range field having a second range for the object based on the first range for the first range pixel and the reference range of the reference point, determine a first range field for the camera image, the first range field including a plurality of first range pixels, each first range pixel corresponding to a respective image pixel and storing a first range for the respective image pixel, obtain a reference field for the viewing area from an auxiliary range sensor, the reference field including a plurality of reference points corresponding to a subset of the plurality of first range pixels, wherein each reference point indicates a reference range of a corresponding first range pixel, determine a correction function from a difference between the plurality of reference points and the subset of the plurality of first range pixels, applying the correction function to the plurality of first range pixels to obtain a plurality of second range pixels of a second range field, each second range pixel corresponding to the respective image pixel and storing a corrected range for the respective image pixel, and navigate the autonomous vehicle with respect to the object based on the second range field.

In addition to one or more of the features described herein, the first range field includes non-subset range pixel that is not a member of the subset of the plurality of first range pixels, wherein obtaining the second range field further comprises obtaining a corrected range for the non-subset range pixel.

In addition to one or more of the features described herein, the processor is further configured to determine the correction function by determining a loss function based on the difference between the plurality of reference points and the subset of the plurality of first range pixels and reducing the loss function to obtain the second range field from the first range field.

In addition to one or more of the features described herein, the processor is further configured to train a convolutional neural network by reducing the loss function and use the trained convolutional neural network to determine the second range field.

In addition to one or more of the features described herein, the processor is further configured to determine a polynomial parameter of a linear equation between the first range and the reference range and use the polynomial parameter to determine the corrected range.

In addition to one or more of the features described herein, the processor is further configured to apply the polynomial parameter to all of the plurality of first range pixels of the first range field.

In addition to one or more of the features described herein, the auxiliary range sensor is at least one of Lidar and radar.

In yet another exemplary embodiment, an autonomous vehicle is disclosed. The autonomous vehicle includes a camera configured to obtain a camera image of a viewing area, wherein an image pixel of the camera image is associated with an object in the viewing area, an auxiliary range sensor for obtaining a reference field for the viewing area, an actuator for controlling navigation of the autonomous vehicle, and a processor. The processor is configured to determine a first range field for the camera image, the first range field including a first range pixel having a first range for the object, determine a reference range for a reference point of the reference field, wherein the reference range corresponds to the first range pixel and indicates a reference range for the object, obtain a second range field having a second range for the object based on the first range for the first range pixel and the reference range of the reference point, determine a first range field for the camera image, the first range field including a plurality of first range pixels, each first range pixel corresponding to a respective image pixel and storing a first range for the respective image pixel, obtain a reference field for the viewing area from an auxiliary range sensor, the reference field including a plurality of reference points corresponding to a subset of the plurality of first range pixels, wherein each reference point indicates a reference range of a corresponding first range pixel, determine a correction function from a difference between the plurality of reference points and the subset of the plurality of first range pixels, applying the correction function to the plurality of first range pixels to obtain a plurality of second range pixels of a second range field, each second range pixel corresponding to the respective image pixel and storing a corrected range for the respective image pixel, and navigate the autonomous vehicle with respect to the object based on the second range field.

In addition to one or more of the features described herein, the first range field includes a non-subset range pixel that is not a member of the subset of the plurality of first range pixels, wherein obtaining the second range field further comprises obtaining the corrected range for the non-subset range pixel.

In addition to one or more of the features described herein, the processor is further configured to determine the correction function by determining a loss function based on the difference between the plurality of reference points and the subset of the plurality of first range pixels and reducing the loss function to obtain the second range field from the first range field.

In addition to one or more of the features described herein, the processor is further configured to train a convolutional neural network by reducing the loss function and use the trained convolutional neural network to determine the second range field.

In addition to one or more of the features described herein, the processor is further configured to determine a polynomial parameter of a linear equation between the first range and the reference range and use the polynomial parameter to determine the second range.

In addition to one or more of the features described herein, the auxiliary range sensor is at least one of Lidar and radar.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle with an associated trajectory planning system, in accordance with an exemplary embodiment;

FIG. 2 shows a camera image obtained from a camera disposed at the vehicle, in an illustrative embodiment;

FIG. 3 shows a first range field obtained from the camera image of FIG. 2;

FIG. 4 shows a reference field including a three-dimensional point cloud;

FIG. 5 is a flowchart of a method for refining the values of ranges in the first range field, in an embodiment;

FIG. 6 is a flowchart of a method of estimating a range of objects within an image using a convolutional neural network, in an illustrative embodiment; and

FIG. 7 shows a flowchart of a method for obtaining a refined range field using least squares polynomial fitting.

### DETAILED DESCRIPTION

The following description is merely exemplary in nature and is not intended to limit the present disclosure, its application or uses. It should be understood that throughout the drawings, corresponding reference numerals indicate like or corresponding parts and features.

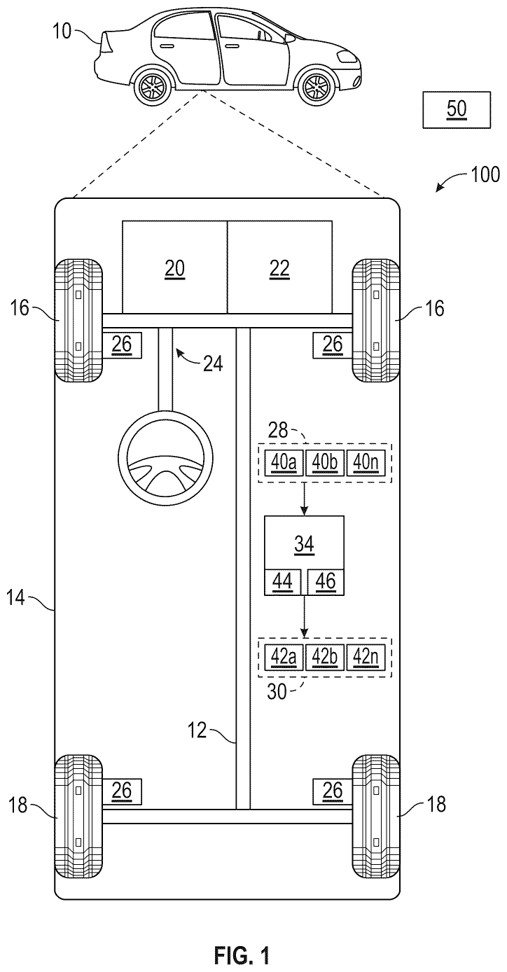

In accordance with an exemplary embodiment, FIG. 1 shows an autonomous vehicle 10 with an associated trajectory planning system depicted at 100. In general, the trajectory planning system 100 determines a trajectory plan for automated driving of the autonomous vehicle 10. The autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a frame. The front wheels 16 and rear wheels 18 are each rotationally coupled to the chassis 12 near respective corners of the body 14.

In various embodiments, the trajectory planning system 100 is incorporated into the autonomous vehicle 10. The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), etc., can also be used. At various levels, an autonomous vehicle can assist the driver through a number of methods, such as warning signals to indicate upcoming risky situations, indicators to augment situational awareness of the driver by predicting movement of other agents warning of potential collisions, etc. The autonomous vehicle has different levels of intervention or control of the vehicle through coupled assistive vehicle control all the way to full control of all vehicle functions. The autonomous vehicle 10 can be a Level Four system or Level Five system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, and a controller 34. The propulsion system 20 may, in various embodiments, include an internal combustion engine, an electric machine such as a traction motor, and/or a fuel cell propulsion system. The transmission system 22 is configured to transmit power from the propulsion system 20 to the front wheels 16 and rear wheels 18 according to selectable speed ratios. According to various embodiments, the transmission system 22 may include a step-ratio automatic transmission, a continuously variable transmission, or other appropriate transmission. The brake system 26 is configured to provide braking torque to the front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensing devices 40a-40n obtain measurements or data related to various objects or agents 50 within the vehicle's environment. Such agents 50 can be, but are not limited to, other vehicles, pedestrians, bicycles, motorcycles, etc., as well as non-moving objects. The sensing devices 40a-40n can also obtain traffic data, such as information regarding traffic signals and signs, etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but not limited to, doors, a trunk, and cabin features such as ventilation, music, lighting, etc. (not numbered).

The controller 34 includes a processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. The instruction may also perform logic, calculations, methods and/or algorithms for determining or increasing an accuracy of ranges to objects in an environment of the vehicle and navigating the vehicle through the environment based on the determined ranges, using the methods disclosed herein.

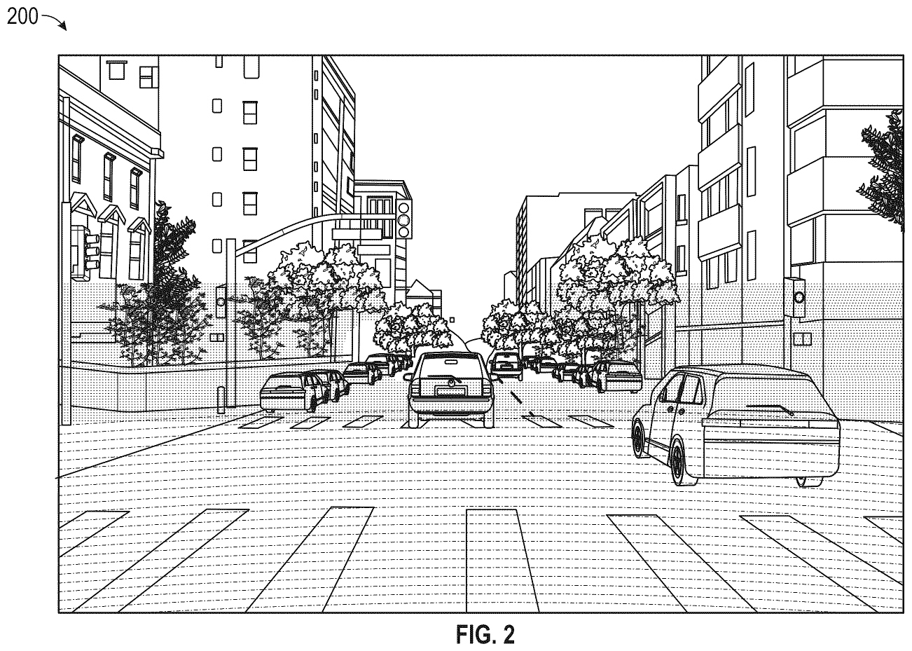

FIG. 2 shows a camera image 200 obtained from a camera disposed at the vehicle, in an illustrative embodiment. The camera image 200 is obtained over a viewing area within the field of view of the camera. The camera image 200 includes various objects at different ranges with respect to the vehicle. The camera image includes an array of image pixels.

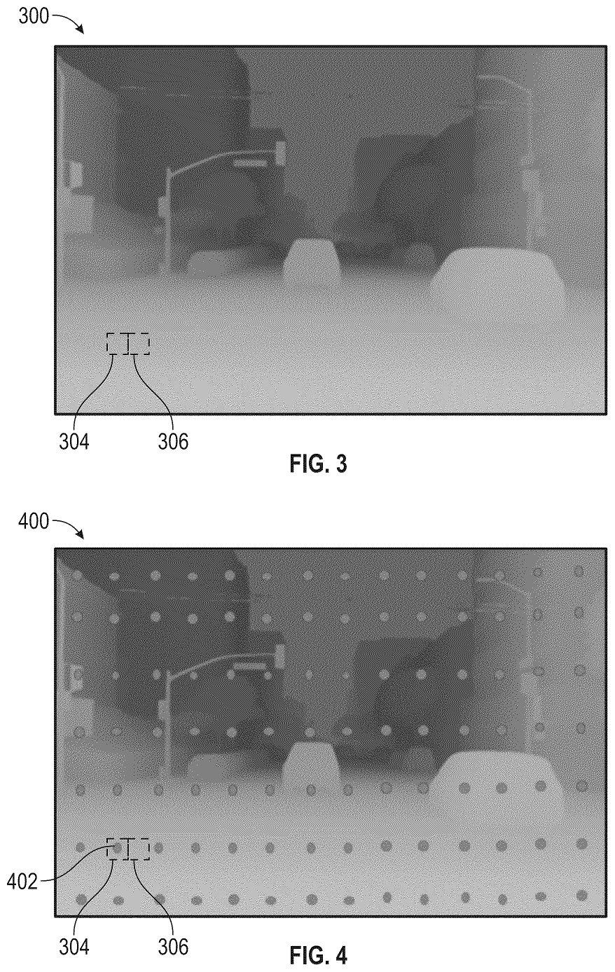

FIG. 3 shows a first range field 300 obtained from the camera image 200 of FIG. 2. The first range field 300 is made of an array of range pixels. Each range pixel corresponds to a respective image pixel of the camera image 200 and stores a value indicating a range for an object associated with the respective image pixel. A first range pixel 304 and a second range pixel 306 are shown for illustrative purposes.

FIG. 4 shows a reference field 400 including a three-dimensional (3D) point cloud. The 3D point cloud can be obtained using an auxiliary range sensor, such as Lidar, radar, etc. The 3D point cloud forms a reference field, with each reference point of the reference field indicating a reference range between the vehicle and an object in the image. The reference field 400 is shown on top of the first range field 300 for ease of illustration. Each reference point in the reference field is associated with a range pixel of the first range field 300. The number of reference points is less than the number of first range pixels. Thus, the reference points of the reference field 400 are associated with a proper subset of the first range pixels of the first range field 300. A first range pixel that is not a member of the proper subset can be referred to as a non-subset pixel. For illustrative purposes, the first range pixel 304 is shown with its associated reference point 402. The reference field 400 can be used to correct or refine various range values within the first range field 300 to obtain an improved range field or a second range field. The range values in the second range field are refined or give more accurate range values for objects within the camera image, as discussed herein.

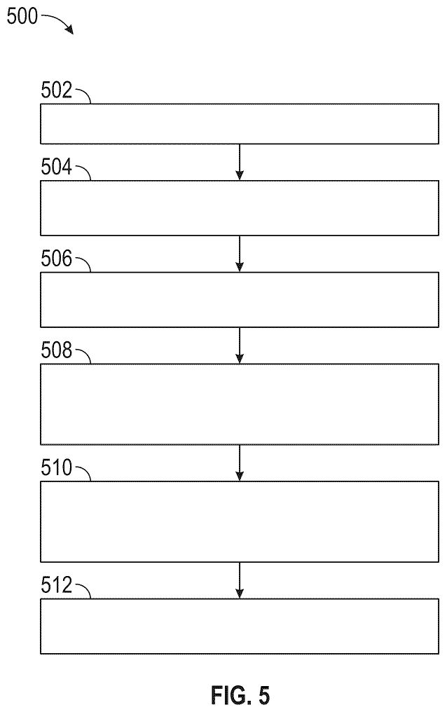

FIG. 5 is a flowchart 500 of a method for refining the values of ranges in the first range field, in an embodiment. In box 502, the camera image is obtained from a camera of the vehicle. In box 504, the first range field is determined from the camera image. This can be determined using standard methods. The first range field includes a plurality of range pixels, each of which stores a value that includes a first range for a corresponding image pixel of the camera image.

In box 506, a three-dimensional point cloud is obtained using a suitable sensing device such as Lidar, radar, etc. The three-dimensional point cloud includes a plurality of reference points. The number of reference points is generally less than the number of range pixels. While each reference point is associated with a range pixel of the first range field, the reference points correspond to a subset of the first range pixels. Each point of the three-dimensional point cloud has a reference range associated with it.

In box 508, the reference ranges of the three-dimensional point cloud are used with the first range pixels to determine a correction function. In box 510, the correction function is used to update or refine the values of the first range pixels of the first range field, thereby obtaining a second range field with the second range values or refined values. In box 512, the vehicle is controlled to steer the vehicle using the second range field, thereby navigating the vehicle with respect to the objects.

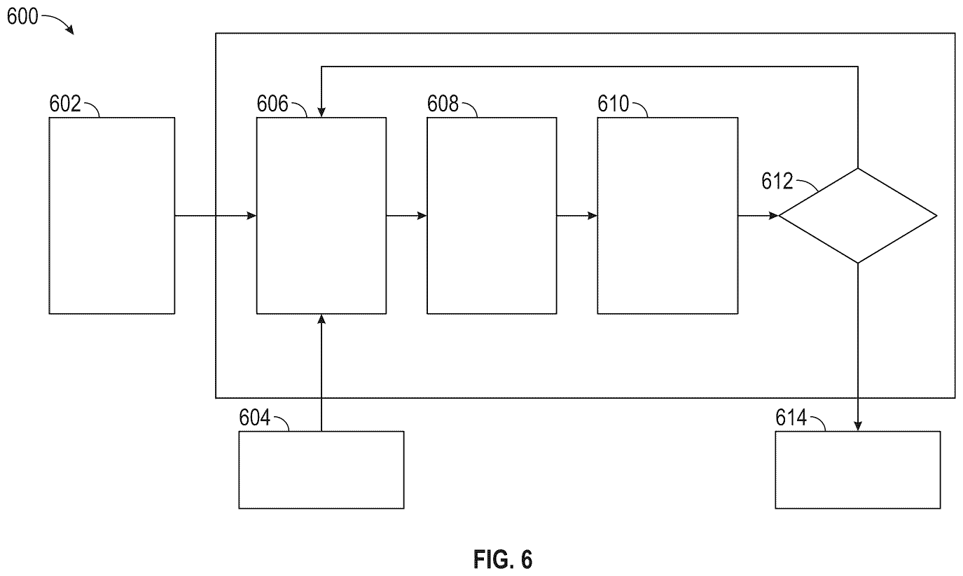

FIG. 6 is a flowchart 600 of a method of estimating a range of objects within an image using a convolutional neural network (CNN), in an illustrative embodiment. In box 602, the first range field 300 is obtained and used as initial values of a work field that is refined using the CNN. In box 604, the reference field 400 is obtained. In box 606, estimated ranges are extracted from the work field (subset of first range field 300) at those pixels that correspond to the reference points of the reference field. In box 608, a loss function is calculated between the work ranges extracted from the work field and the references ranges of the reference field. The loss function can be an L2 norm.

In box 610, the work field and the reference field are entered into a convolutional neural network (CNN) to train the CNN. The CNN calculates a new work field that reduces the loss function. In box 612, the loss function is compared to a convergence criterion. If the loss function has not converged to the convergence criterion (i.e., if loss>=epsilon), the method returns to box 606, using the work field output by the CNN. If, in box 612, the loss function has converged to the convergence criterion (i.e., if loss<epsilon), then the CNN is considered to be a trained CNN and the method proceed to box 614. The trained CNN is able to subsequently apply a correction function to a range field. In box 614, the CNN is applied to the first range field to obtain a refined range field (i.e., the second range field).

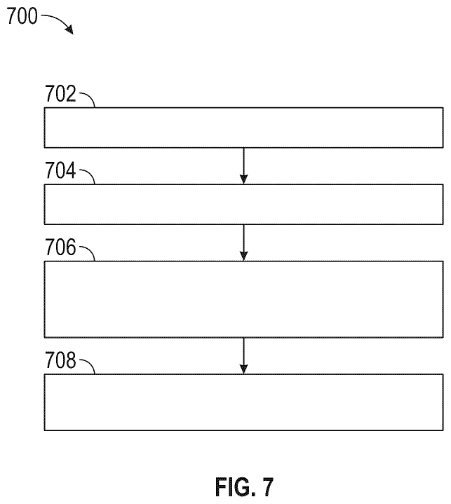

FIG. 7 shows a flowchart 700 of a method for obtaining a refined range field using least squares polynomial fitting. In box 702, the first range field is obtained of a viewing field of the vehicle. The ranges of a subset (i.e., a proper subset) of the first range field are given as d₁, d₂, . . . , dᵢ, . . . , dₚ, where dᵢ is the range associated with the i^{th} range pixel and p is the cardinality of the subset.

In box 704, a reference field is obtained of the viewing field. Reference ranges are indicated by n, as shown in Eq. (1):

$$η = [ \begin{matrix}{η}_{1} \\ {η}_{2} \\ ⋮\end{matrix} ] \qquad Eq . ( 1 )$$

where ηᵢ is the reference range for the i^{th} reference point.

In box 706, polynomial parameters b are obtained by performing a least squares polynomial estimation on the subset of the range pixels dᵢ of the first range field and their corresponding reference points ηᵢ in the reference field. A relation between the first ranges and the reference ranges is given by the linear equation shown in Eq. (2):

$$η = Hb \qquad Eq . ( 2 )$$

$$where$$

$$H = [ \begin{matrix}1 & {d}_{1} & {d}_{1}^{2} \\ 1 & {d}_{2} & {d}_{2}^{2} \\ 1 & {d}_{3} & {d}_{3}^{2} \\ ⋮ & ⋮ & ⋮\end{matrix} ] \qquad Eq . ( 3 )$$

is an array including powers of the original range of the selected pixels, and

$$b = [ \begin{matrix}{b}_{1} \\ {b}_{2} \\ ⋮\end{matrix} ] \qquad Eq . ( 4 )$$

is a vector including polynomial parameters for the original powers of the ranges. The polynomial parameters can be determined from Eq. (2), as shown in Eq. (5):

b=(H^{T}H)⁻¹H^{T}η Eq. (5)

The polynomial parameters determined in Eq. (5) are parameters of a correction function that can subsequently be used to correct the range field.

In box 708, the polynomial parameters obtained in box 706 are applied to the entire first range field (including those non-subset range pixels that are not in the subset) to obtain the refined range field n (i.e., second range field), as sown in Eqs. (6)-(7):

$${η}^{′} = {H}^{′} b \qquad Eq . ( 6 )$$

$$where$$

$${H}^{′} = [ \begin{matrix}1 & {d}_{1}^{′} & {d}_{1}^{2} \\ 1 & {d}_{2}^{′} & {d}_{2}^{2} \\ 1 & {d}_{3}^{′} & {d}_{3}^{2}\end{matrix} \qquad Eq . ( 7 )$$

and d′ is all of the range pixels.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of navigating an autonomous vehicle, comprising:
obtaining a camera image of a viewing area, wherein an image pixel of the camera image is associated with an object in the viewing area;
determining a first range field for the camera image, the first range field including a plurality of first range pixels, each first range pixel corresponding to a respective image pixel and storing a first range for the respective image pixel;
obtaining a reference field for the viewing area from an auxiliary range sensor, the reference field including a plurality of reference points corresponding to a subset of the plurality of first range pixels, wherein each reference point indicates a reference range of a corresponding first range pixel of the subset of first range pixels;
determining a correction function from a difference between the plurality of reference points and the subset of the plurality of first range pixels;
applying the correction function to the plurality of first range pixels to obtain a plurality of second range pixels of a second range field, each second range pixel corresponding to the respective image pixel and storing a corrected range for the respective image pixel; and
navigating the autonomous vehicle with respect to the object based on the second range field.

2. The method of claim 1, wherein the first range field includes a non-subset range pixel that is not a member of the subset of the plurality of first range pixels, wherein obtaining the second range field further comprises obtaining the corrected range for the non-subset range pixel.

3. The method of claim 1, further comprising determining the correction function further comprising determining a loss function based on the difference between the plurality of reference points and the subset of the plurality of first range pixels and reducing the loss function to obtain the second range field from the first range field.

4. The method of claim 3, further comprising training a convolutional neural network by reducing the loss function and using the trained convolutional neural network to determine the second range field.

5. The method of claim 3, further comprising determining a polynomial parameter of a linear equation between the first range and the reference range and using the polynomial parameter to determine the corrected range.

6. The method of claim 5, further comprising applying the polynomial parameter to all of the plurality of first range pixels of the first range field.

7. The method of claim 1, wherein the auxiliary range sensor is at least one of: (i) Lidar; and (ii) radar.

8. A system for navigating an autonomous vehicle, comprising:
a camera configured to obtain a camera image of a viewing area, wherein an image pixel of the camera image is associated with an object in the viewing area;
an auxiliary range sensor for obtaining a reference field for the viewing area;
a processor configured to:
determine a first range field for the camera image, the first range field including a first range pixel having a first range for the object;
determine a reference range for a reference point of the reference field, wherein the reference range corresponds to the first range pixel and indicates a reference range for the object;
obtain a second range field having a second range for the object based on the first range for the first range pixel and the reference range of the reference point;
determine a first range field for the camera image, the first range field including a plurality of first range pixels, each first range pixel corresponding to a respective image pixel and storing a first range for the respective image pixel;
obtain a reference field for the viewing area from an auxiliary range sensor, the reference field including a plurality of reference points corresponding to a subset of the plurality of first range pixels, wherein each reference point indicates a reference range of a corresponding first range pixel;
determine a correction function from a difference between the plurality of reference points and the subset of the plurality of first range pixels;
applying the correction function to the plurality of first range pixels to obtain a plurality of second range pixels of a second range field, each second range pixel corresponding to the respective image pixel and storing a corrected range for the respective image pixel; and
navigate the autonomous vehicle with respect to the object based on the second range field.

9. The system of claim 8, wherein the first range field includes non-subset range pixel that is not a member of the subset of the plurality of first range pixels, wherein obtaining the second range field further comprises obtaining a corrected range for the non-subset range pixel.

10. The system of claim 8, wherein the processor is further configured to determine the correction function by determining a loss function based on the difference between the plurality of reference points and the subset of the plurality of first range pixels and reducing the loss function to obtain the second range field from the first range field.

11. The system of claim 10, wherein the processor is further configured to train a convolutional neural network by reducing the loss function and use the trained convolutional neural network to determine the second range field.

12. The system of claim 10, wherein the processor is further configured to determine a polynomial parameter of a linear equation between the first range and the reference range and use the polynomial parameter to determine the corrected range.

13. The system of claim 12, wherein the processor is further configured to apply the polynomial parameter to all of the plurality of first range pixels of the first range field.

14. The system of claim 8, wherein the auxiliary range sensor is at least one of: (i) Lidar; and (ii) radar.

15. An autonomous vehicle, comprising:
a camera configured to obtain a camera image of a viewing area, wherein an image pixel of the camera image is associated with an object in the viewing area;
an auxiliary range sensor for obtaining a reference field for the viewing area;
an actuator for controlling navigation of the autonomous vehicle;
a processor configured to:
determine a first range field for the camera image, the first range field including a first range pixel having a first range for the object;
determine a reference range for a reference point of the reference field, wherein the reference range corresponds to the first range pixel and indicates a reference range for the object;
obtain a second range field having a second range for the object based on the first range for the first range pixel and the reference range of the reference point;
determine a first range field for the camera image, the first range field including a plurality of first range pixels, each first range pixel corresponding to a respective image pixel and storing a first range for the respective image pixel;
obtain a reference field for the viewing area from an auxiliary range sensor, the reference field including a plurality of reference points corresponding to a subset of the plurality of first range pixels, wherein each reference point indicates a reference range of a corresponding first range pixel;
determine a correction function from a difference between the plurality of reference points and the subset of the plurality of first range pixels;
applying the correction function to the plurality of first range pixels to obtain a plurality of second range pixels of a second range field, each second range pixel corresponding to the respective image pixel and storing a corrected range for the respective image pixel; and
navigate the autonomous vehicle with respect to the object based on the second range field.

16. The autonomous vehicle of claim 15, wherein the first range field includes a non-subset range pixel that is not a member of the subset of the plurality of first range pixels, wherein obtaining the second range field further comprises obtaining the corrected range for the non-subset range pixel.

17. The autonomous vehicle of claim 15, wherein the processor is further configured to determine the correction function by determining a loss function based on the difference between the plurality of reference points and the subset of the plurality of first range pixels and reducing the loss function to obtain the second range field from the first range field.

18. The autonomous vehicle of claim 17, wherein the processor is further configured to train a convolutional neural network by reducing the loss function and use the trained convolutional neural network to determine the second range field.

19. The autonomous vehicle of claim 17, wherein the processor is further configured to determine a polynomial parameter of a linear equation between the first range and the reference range and use the polynomial parameter to determine the second range.

20. The autonomous vehicle of claim 15, wherein the auxiliary range sensor is at least one of: (i) Lidar; and (ii) radar.
